(19) United States
(12) Patent Application Publication
(10) Pub. No.: US 2005/0013341 A1
(43) Pub. Date: Jan. 20, 2005

(54) Laser brightness

(76) Inventor: Shahin Baghai, Trumbull, CT (US)

Correspondence Address: WILLIAM ANTHONY DRUCKER;Suite 800, 13th Floor, 1901 L Street, N.W., Washington, DC, 20036-3506, US

(21) Appl. No.: 10/882,924

(22) Filed: Jul. 1, 2004

Related U.S. Application Data
(60) Provisional application No. 60/486,951, filed on Jul. 14, 2003.

(51) Int. Cl. H01S 3/098

(52) U.S. Cl. 374/120

(57) ABSTRACT

An infra-red measurement radiometer is disclosed having one or more laser emitters (10) to define a sighting area, characterised in that the brightness of the laser beams (24) emitted is controllable by the operator. Brightness of the laser beams can be increased or decreased to a useful extent by switching more or less lasers into or out of operations. Brightness can be reduced by optical attenuation, such as the interposition of an optical element between the laser and the target, such as a diffraction lens or an iris device, or by use of an optical brightness filter, as in photography. It is also possible to change the laser beam brightness by variation of the electrical power supply (Vₛ) to the laser emitter (10). This can be done with a resistor circuit (12), which may be fixed, or variable, and which may be located electrically between the laser emitter and power source, which is commonly a DC dry cell battery. In accordance with the invention, the operator of an instrument is able to adjust the laser brightness, within safety limits, which allow enough brightness to be both safe and useful. When the target measurement or treatment area is located at a relatively long distance away from the instrument, or in obscure illumination conditions, greater laser brightness becomes valuable.

This invention relates to the use of laser beams to identify the location and size of a target surface area for measurement or treatment and in particular relates to controlling the brightness of such laser beams.

It is known in the art of non-contact temperature measurement to direct an infra-red radiometer, having a field of view, at a target surface to measure invisible heat radiation emanating therefrom and to identify the target location and size by projection of one or more visible laser beams onto the target, so that the radiometer user can visualise and identify the target area detected by the radiometer.

It is known to use either moving or stationary laser beams for targetting and to project one or more beams to identify the extent and location of the target area. Our co-pending European application number (based on U.S. 60/478,935) describes a device having at least two laser emitters defining the sighting area. The laser sighting device can be mounted on a hand-held instrument, including an infra-red detector or radiometer.

When laser sighting is used with a measurement device, there are limiting operational features. The laser light must be bright enough to be seen on the target, even at a substantial distance from the instrument, but the laser light must not be so bright as to risk damage to the eye. Sometimes the laser sighting light must penetrate vapours or smoke or fumes to reach the target and then to be seen.

Current instruments employing lasers tend to use the lowest workable brightness, which is cheaper and safer since brighter lasers require greater safety regulation and control.

The present invention seeks to provide an instrument wherein the laser brightness, within safety limits, is controllable by the operator.

According to the present invention, there is provided an infra-red measurement radiometer having one or more laser emitters to define a sighting area, characterised in that the brightness of the laser beams emitted is controllable by the operator.

Brightness of the laser beams can be increased or decreased to a useful extent by switching more or less lasers into or out of operations. Brightness can be reduced by optical attenuation, such as the interposition of an optical element between the laser and the target, such as a diffraction lens or an iris device, or by use of an optical brightness filter, as in photography.

It is also possible to change the laser beam brightness by variation of the electrical power supply to a laser emitter. This can be done with a resistor circuit, which may be fixed, or variable, and which may be located electrically between the laser emitter and power source, which is commonly a DC dry cell battery.

In accordance with the invention, the operator of an instrument is able to adjust the laser brightness, within safety limits, which allow enough brightness to be both safe and useful. When the target measurement or treatment area is located at a relatively long distance away from the instrument, or in obscure illumination conditions, greater laser brightness becomes valuable.

For commercial and safety reasons, laser devices are commonly classified in brightness as Class 2 (less than 1 milliwatt), or Class 3A (less than 5 milliwatt), or Class 3B (more than 5 milliwatt), as measured under standardised conditions. Brighter lasers require greater safety regulation and control. Use of the lowest workable brightness is cheaper and safer. According to the invention, means are employed to obtain optimal safe laser illumination of a target measurement or treatment area.

The following table shows a relationship between laser voltage supply, brightness and classification.

Laser Brightness/
Power Output

| Supply Voltage | #1 | #2 | Classification |
|---|---|---|---|
| 2.20 VDC | 0.225 mw | 0.370 W | Class 2 |
| 2.24 VDC | 0.874 mW | 0.986 mW | Class 2 |
| 2.30 VDC | 1.355 mW | 1.435 mW | Class 3A |
| 2.50 VDC | 1.822 mW | 1.871 mW | Class 3A |
| 2.75 VDC | 2.25 mW | 2.231 mW | Class 3A |
| 3.20 VDC | 2.93 mW | 2.963 W | Class 3A |
| 3.60 VDC | 3.630 mW | 3.685 mW | Class 3A |
| 4.00 VDC | 4.42 mW | 4.57 mW | Class 3A |
| 4.50 VDC | 5.57 mW | 5.62 mW | Class 3B |

Thus, brightness is controlled from about 0.3 mW to about 5.6 mW by a change in supply voltage.

The brightness of one or more lasers mounted on a hand held measurement instrument with integral power supply may be controlled by power switching control as managed by the operator. This can be used together with optical attenuation and selection of the number of active lasers.

Any or all of the lasers in the device of the invention may be mounted so as to be able to tilt or swivel together or independently so that the operator can direct their beams as desired.

The invention will now be described, by way of example, with reference to the accompanying drawings, in which:

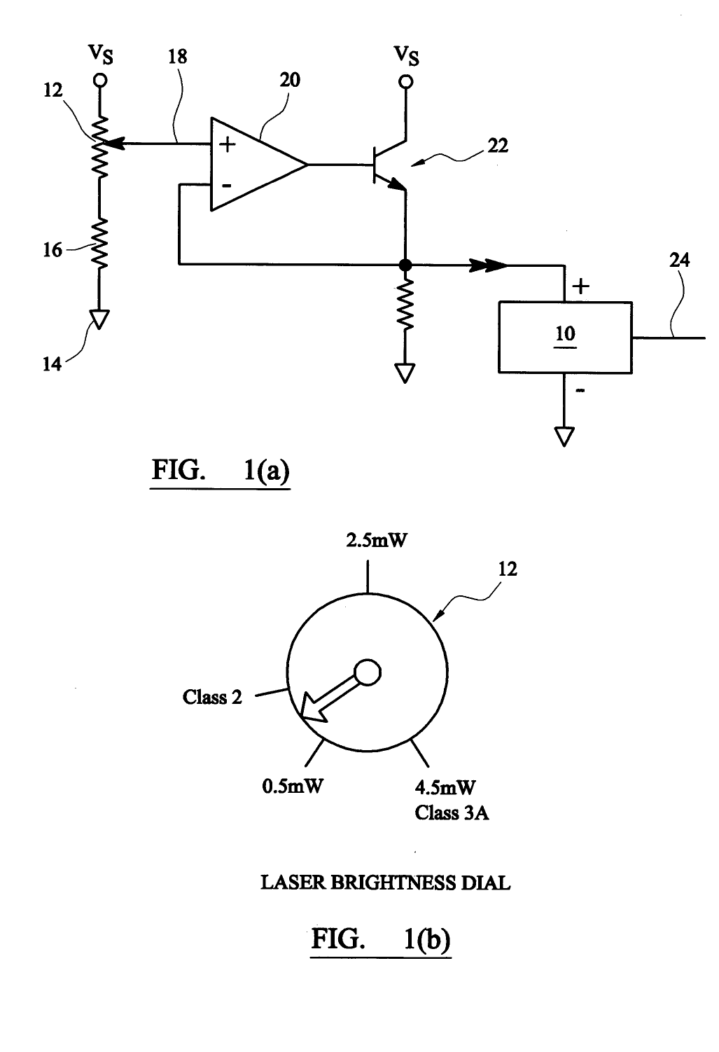

FIG. 1(a) is a circuit diagram of an electrical method of laser brightness control, and FIG. 1(b) is a detail of the potentiometer used;

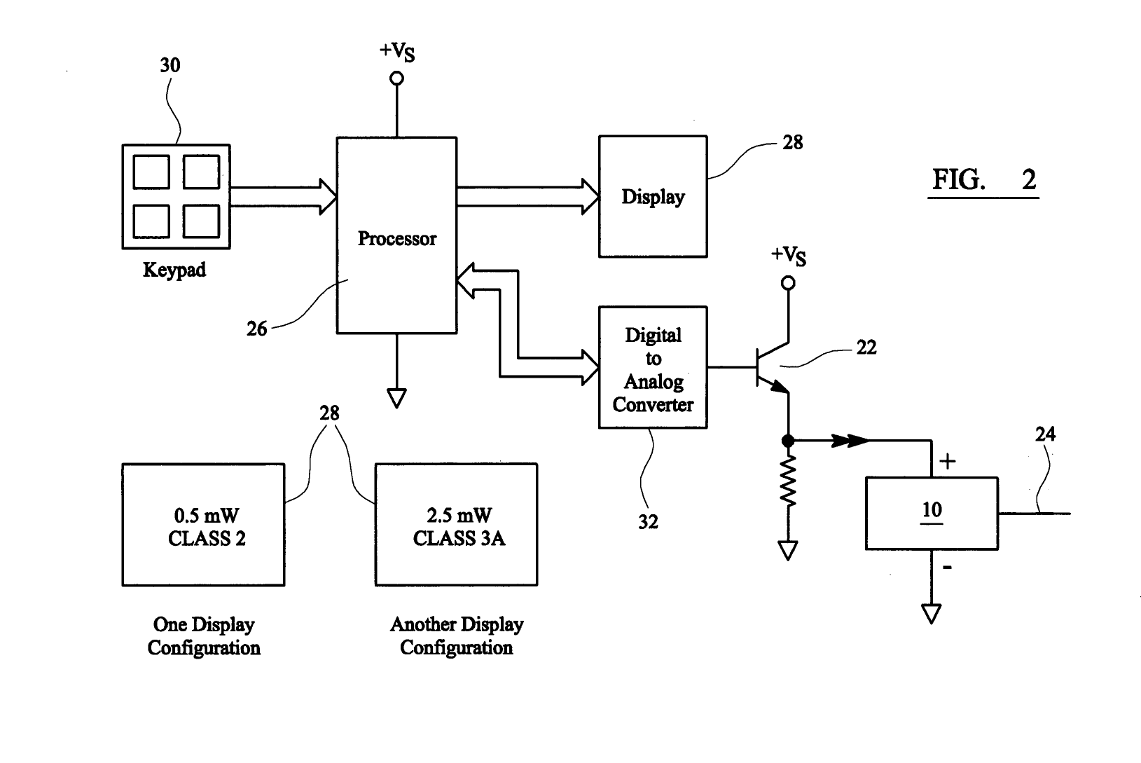

FIG. 2 is a circuit diagram of a laser brightness control system employing a micro-processor; and

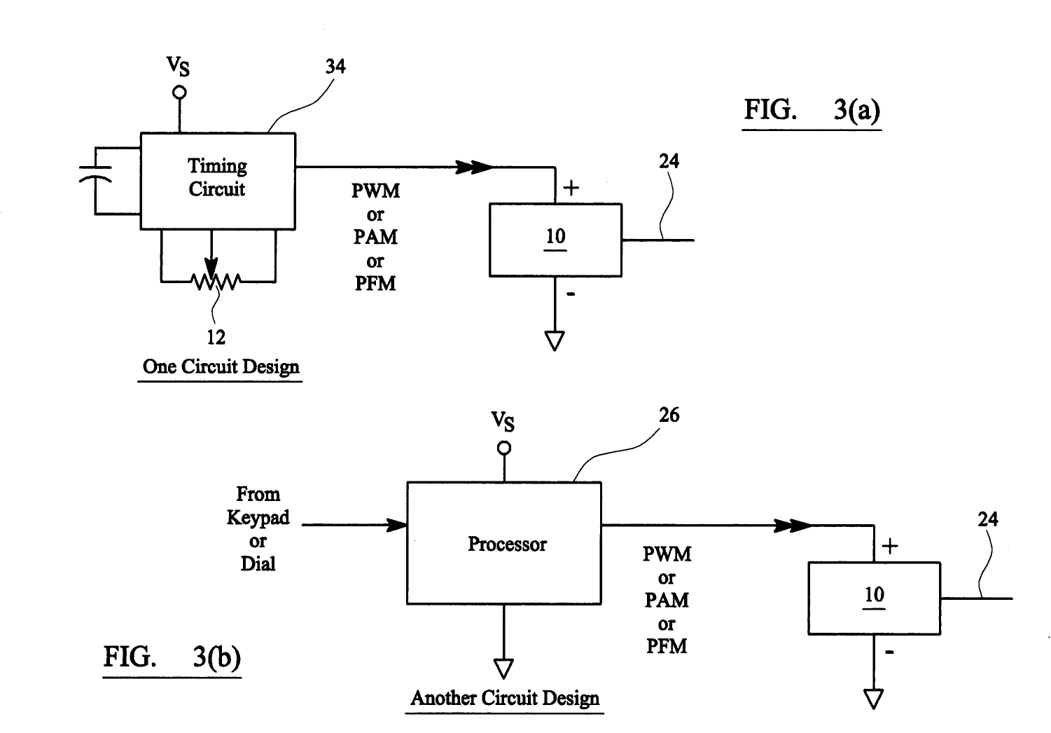

FIGS. 3(a) and (b) are two circuit diagrams of laser control devices employing laser modulation.

Referring to the drawings, and in particular FIG. 1, which illustrates a power, and hence brightness, control circuit for a laser emitter device or module (10) which comprises a potentiometer (12) connected between a voltage supply Vₛ and ground (14) through a resistor (16). The output (18) from the potentiometer (12) goes through an amplifier (20) to a transistor (22), in turn connected to the laser device. Variation of the potentiometer (12) causes the power fed to the laser device (10) to be varied accordingly. The device (10) emits a laser beam (24), the brightness of which varies in step with the power. The potentiometer (12) is illustrated in detail in FIG. 1(b), where it can be seen that its dial is labelled to indicate the level of brightness or optical power output. For example, the dial may indicate from 0.5 to 4.5 milliwatts with indicating marks for Class 2 and Class 3A limits. The potentiometer (12) is a single turn potentiometer, but other devices to adjust the laser brightness may be employed, such as a slide switch or a twistable knob projection control.

Turning now to FIG. 2, the laser brightness control system illustrated here includes a micro-processor (26) connected to a display (28) and having a keypad (30) input. Output from the processor (26) is connected, via a digital-to-analogue convertor (32) and a transistor (34), to a voltage supply Vₛ to a laser device (10) as before. The keypad (30) is used to adjust the power output and, as the keypad adjusts the output, the display (28) indicates the brightness and classification limit, e.g. as shown inset in FIG. 2.

Further laser control methods involve pulsing, such as pulse width modulation (PWS), pulse amplitude modulation (PAM), or pulse frequency modulation (PFM), as shown in FIG. 3. In FIG. 3(a) the width of pulse is varied in proportion to laser brightness by means of a timing circuit (34). In FIG. 3(b), a processor (26) is employed to vary the width, amplitude or frequency of the power pulse in proportion to the laser brightness.

The various pulse modulation modes can be used individually or together sequentially in the same device or simultaneously.

The device of the present invention enables the operator in a simple and inexpensive manner to control the brightness of laser beams with an infra-red detection device to produce optimum brightness while remaining within margins of safety.

1. In an infra-red measurement radiometer having one or more laser emitters to define a sighting area, the improvement which comprises the brightness of the laser beams emitted being controllable by the operator.

2. A radiometer as claimed in claim 1 wherein the brightness of the laser beams is increased or decreased by switching more or less lasers into or out of operation.

3. A radiometer as claimed in claims 1 wherein brightness is reduced by optical attenuation.

4. A radiometer as claimed in claim 3 wherein the optical attenuation comprises the interposition of an optical element between the laser and the target.

5. A radiometer as claimed in claim 4 wherein the optical element is a diffraction lens, an iris device, or an optical brightness filter.

6. A radiometer as claimed in claim 1 wherein the laser beam brightness is changed by variation of the electrical power supply to one or more of the laser emitters.

7. A radiometer as claimed in claim 6 wherein the variation in electrical power is achieved with a fixed or variable resistor circuit located electrically between the laser emitter and a power source.

8. A method of controlling the brightness of a laser beam identifying the location and size of a target area for measurement which comprises:
providing means to increase or decrease the brightness of one or more of the laser beams; and
increasing or decreasing the laser brightness according to operational requirements, within safety limits.

9. A method as claimed in claim 8 wherein the brightness of the laser beams is increased or decreased by switching more or less lasers into or out of operation.

10. A method as claimed in claim 8 wherein the brightness is reduced by optical attenuation.

11. A method as claimed in claim 10 wherein the optical attenuation comprises the interposition of an optical element between the laser and the target.

12. A method as claimed in claim 11 wherein the optical element is a diffraction lens, an iris device, or an optical brightness filter.

13. A method as claimed in claim 8 wherein the laser beam brightness is changed by variation of the electrical power supply to one or more of the laser emitters.

14. A method as claimed in claim 13 wherein the variation in electrical power is achieved with a fixed or variable resistor circuit located electrically between the laser emitter and a power source.
